(19) United States
(12) Patent Application Publication
(10) Pub. No.: US 2016/0092814 A1
(43) Pub. Date: Mar. 31, 2016

(54) TIRE PRODUCTION MANAGEMENT SYSTEM USING RFID TAG

(71) Applicant: ASIANA IDT INC., Seoul (KR)

(72) Inventors: Jong Sup Yun, Incheon (KR); Nam Hoon Kim, Gyeonggi-do (KR); Uh Chul Jeon, Gyeonggi-do (KR); Young Dae Sim, Seoul (KR); Jin Kweon Kim, Gwangju (KR); Bong Souck Ko, Gwangju (KR)

(21) Appl. No.: 14/891,157

(22) PCT Filed: Apr. 28, 2014
(86) PCT No.: PCT/KR2014/003724

§ 371 Date: Nov. 13, 2015

(30) Foreign Application Priority Data
May 15, 2013 (KR) 10-2013-0055273

(51) Int. Cl. G06Q 10/06; B29D 30/06; B29D 30/00; G06Q 10/08

(52) U.S. Cl. CPC G06Q 10/06313; G06Q 10/087; G06Q 10/083; B29D 30/0601; B29D 30/0061; B29D 2030/0077

(57) ABSTRACT

Disclosed is a tire production management system, and more particularly to, a tire production management system using a radio frequency identification (RFID) tag, which may attach an RFID tag to a tire before producing a finished tire in tire manufacturing processes, recognize the tire tag attached to the tire in each of manufacturing processes, and thus manage information according to a manufacturing process on an individual tire. The tire production management system using an RFID tag comprises: an RFID tag attachment part; a plurality of RFID readers; a plurality of management terminals for respective processes; a lot management server; and a tire production management server.

### TECHNICAL FIELD

The present disclosure relates to a tire production management system, and more particularly to, a tire production management system using a radio frequency identification (RFID) tag, which may attach an RFID tag to a tire before producing a finished tire in tire manufacturing processes, recognize the tire tag attached to the tire in each of manufacturing processes, and thus manage information according to a manufacturing process on an individual tire.

### BACKGROUND ART

Since the quality of a tire is linked directly with the life of a driver, an effort to make the quality of the tire good is being required in a production process. As an example, Firestone Tire and Rubber Company of U.S distributed defective tires, recalled 6.5 million tires due to the death of 119 people but eventually went bankrupt due to a ripple effect. To that extent, the quality in a tire industry equals life and is linked with the existence of a company. Even in a domestic case, a problem associated with the tire quality is frequently arising such as explosion of a city bus employing a recapped tire. Also, there are human injuries/material damages due to the employing of a tire that has passed the expiration date.

From a tire manufacturer, it is also significantly important to maintain the excellent quality of the tire and increase production efficiency at the same time to save time and money consumed for tire manufacturing.

As such, in order to enhance the quality of the tire and the manufacturing efficiency of the tire, a study on assigning a barcode to an individual tire in a tire manufacturing process to manage tire production according to a process and on managing a production history of the individual tire has been conducted and some sites have introduced the study. However, a barcode system has a limitation in that it frequently has cases where a printed barcode is deleted or contaminated due to the severe environment of the tire production process and thus it is difficult to recognize the barcode.

In order to solve such limitations, a recognition system using a radio frequency identification (RFID) tag is being proposed. Korean Utility Model No. 20-0378000 that is a related literature proposes a tire recognition system using an RFID. However, the related literature only discloses a device for recognizing a tag using an RFID inserted into a tire and does not disclose a system for integrated management/supervision on tire production by using production information according to a process on an individual tire.

### DISCLOSURE OF THE INVENTION

### Technical Problem

Embodiments provide a tire production management system using a radio frequency identification (RFID) tag that may integrally management production information on the individual tire produced by using an RFID tag.

### Technical Solution

In one embodiment, a tire production management system using a radio frequency identification (RFID) tag includes

an RFID tag attachment device attaching, an RFID tag on which an identification code of a tire is recorded, to a semi-finished tire which is made in an intermediate process for manufacturing the tire;

a plurality of RFID readers reading the identification code recorded on the RFID tag which is attached to the semi-finished tire made in each of a plurality of processes for manufacturing the tire, or to a finished tire;

a plurality of process-dependent management terminals disposed for the plurality of processes to generate production information on a corresponding process;

a lot management server combining the identification code read by the plurality of RFID readers with the production information generated by the for the process-dependent management terminals for the tire having a corresponding identification code; and

a tire production management server receiving, data in which the identification code is combined with the production information on the corresponding process, from the lot management server, and storing/managing tire production information.

The plurality of processes for manufacturing the tire may include a molding process in which semi-finished products configuring a part of the tire are assembled and a green case is molded; a vulcanization process in which heat/pressure is applied to the green case to make a shape of a finished-tire; a test process in which the tire made in the vulcanization process is tested; and a sorting process in which the tire on which the test process is completed is sorted by size.

The RFID tag attachment device may attach the RFID tag to the green case manufactured by the molding process.

The RFID tag attachment device may attach the RFID tag to a bead portion or an inner liner surface of the green case manufactured by the molding process.

The plurality of RFID readers and the plurality of process-dependent management terminals may be disposed one by one at workplaces for the molding process, the vulcanization process, the test process, and the sorting process, and the lot management server may receive the identification code of the tire from the RFID reader in each process and the production information on each process from the process-dependent management terminal in each process, combine the identification code of the tire received in each process with the production information on a process that receives the identification code of the tire, and provide the combined information to the tire production management server.

The production information generated by the management terminal in the molding process may include information on a molding lot to which an individual tire belongs, the work date on which the molding process is performed, molding equipment information, a worker and work group that performs the molding process, and a molding specification.

The production information generated by the management terminal in the vulcanization process may include information on a vulcanization lot to which an individual tire belongs, the work date on which the vulcanization process is performed, vulcanization equipment information, a worker and work group that performs the vulcanization process, and a vulcanization specification.

The production information generated by the management terminal in the test process may include information on a test lot to which an individual tire belongs, the work date on which the test process is performed, a worker and work group that perform the test process, a test specification, and grade information assigned to an individual tire according to a test result.

The production information generated by the management terminal in the sorting process may include specification information on a sorted, individual tire and information on shipment date and place of shipment.

The tire production management server may use lot information generated in each of the plurality of processes to generate a lot state, generate an inventory state according to each of the plurality of processes, and generate a quality state of a semi-finished/finished tire according to facilities applied to the plurality of processes and a quality state by day/month in which each process is performed.

The tire production management server may generate an inventory according to a specification of a sorted tire, and generate place of shipment according to tire specification.

The tire production management server may collect daily production information to generate/manage production performance, and generate a state of a tire according to various test results, such as a defect/repair/disuse.

### Advantageous Effects

According to the inventive concept, by attaching a radio frequency identification (RFID) tag including a recognition code of a corresponding tire to a green case manufactured in a tire molding process, and combining production information on each tire according to a subsequent production process of a tire with the recognition code of the RFID tag for integrated management, there are effects in that it is possible to perform history management according to a production process on an individual tire and it is possible to perform integrated tire production management, such as tire inventories, defects, shipment, etc.

### BRIEF DESCRIPTION OF THE DRAWINGS

FIG. 1 is a block diagram of a tire production management system using a radio frequency identification (RFID) tag according to an embodiment of the inventive concept.

FIG. 2 shows an example of production information generated according to a tire manufacturing process in a tire production management system using an RFID tag according to an embodiment of the inventive concept.

FIGS. 3a and 3b show an RFID tag used for a tire production management system using an RFID tag according to an embodiment of the inventive concept, in which FIG. 3a is a top view and FIG. 3b is a side cross-sectional view.

FIGS. 4a and 4b show examples of where an RFID tag used in a tire production management system using an RFID tag according to an embodiment of the inventive concept is attached to a tire.

FIG. 5 shows a code system that is recorded on an RFID chip of an RFID tag used in a tire production management system using an RFID tag according to an embodiment of the inventive concept.

### MODE FOR CARRYING OUT THE INVENTION

In the following, an embodiment of the inventive concept is described in more detail with reference to the accompanying drawings. However, the embodiment of the present invention may be varied in different forms and the scope of the present invention is not limited to the embodiment described below. The embodiment of the present invention is provided to more fully explain the present invention to a person skilled in the art. Also, since in describing the present invention, defined terms are defined in consideration of functions in the present invention and may vary according to the intention or practice of a person skilled in the art, the terms should not be understood as limiting the technical component of the present invention.

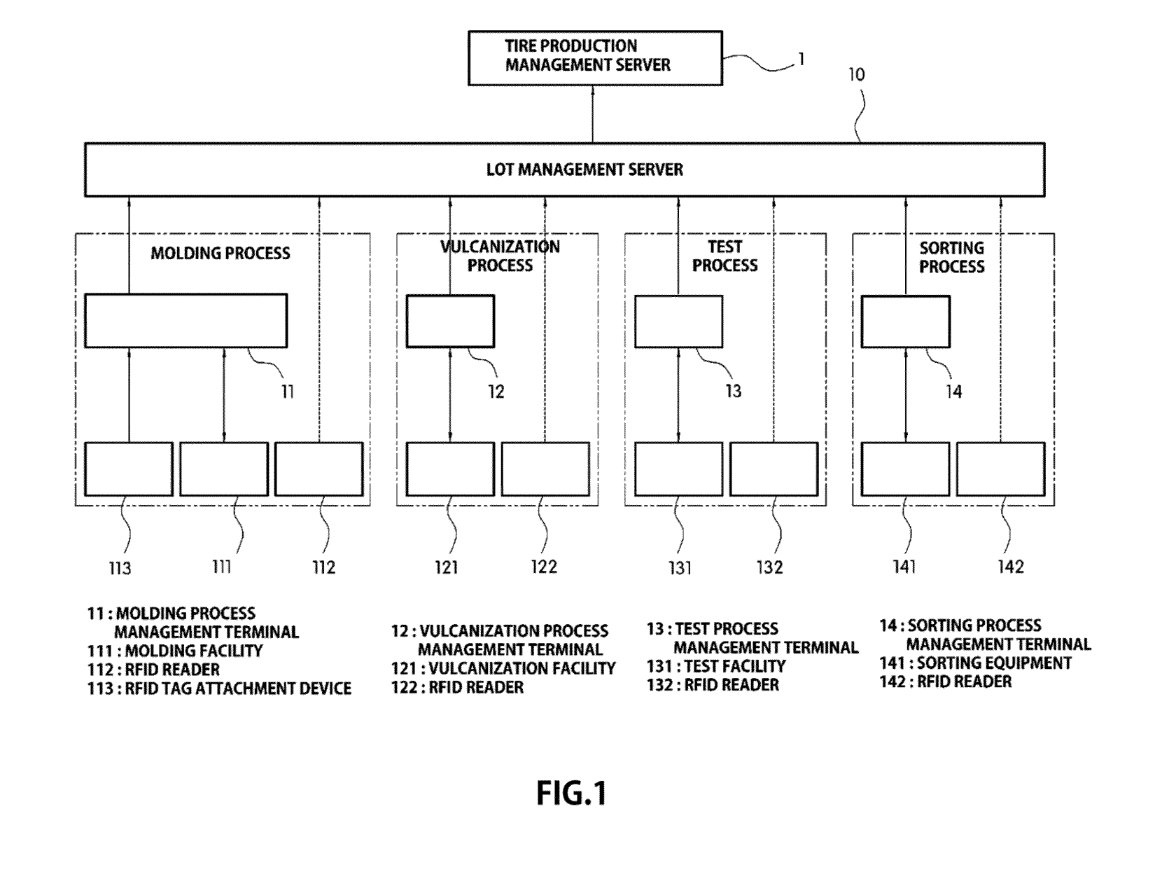

FIG. 1 is a block diagram of a tire production management system using a radio frequency identification (RFID) tag according to an embodiment of the inventive concept.

Referring to FIG. 1, a tire production management system using an RFID tag according to an embodiment of the inventive concept may include a tire production management server 1 that integrally manages production information on an individual tire that has been produced, a lot management server 10 that combines production information on a plurality of tire manufacturing processes with a tire identification code recognized in a corresponding process and provides the combined information to the tire production management server 1, a plurality of process-dependent management terminals 11 to 14 that controls a plurality of tire manufacturing process dependent facilities and generates production information on a corresponding process, process-dependent facilities 111, 121, 131, and 141, an RFID tag attachment device 113, and a plurality of RFID readers 112, 122, 132, and 142 that are disposed for the plurality of tire manufacturing processes, respectively and attached to a semi-finished tire that has been manufactured in a corresponding process.

The tire production management server 1 may receive, store and manage the production information on the individual tire uploaded from the management terminals 11 to 14 that are disposed for respective tire manufacturing processes.

The lot management server 10 combines the production information provided from each of the process-dependent management terminals 11 to 14, with an individual tire code read from the RFID readers 112, 122, 132, and 142 that are disposed for respective processes, and uploads the combined information to the tire production management server 1.

The process-dependent management terminals 11 to 14 control corresponding process-dependent facilities, generate production information on each process and upload the generated information to the lot management server 10.

The process-dependent facilities 111, 121, 131, and 141 may receive control commands from the management terminals 11 to 14 for corresponding processes, respectively, operate according to the control command, and upload actual production information applied to tire manufacturing to the management terminals 11 to 14 for corresponding processes.

The RFID attachment device 113 may attach an RFID tag to a molded tire (green case) manufactured through a molding process.

The plurality of RFID readers 112, 122, 132, and 142 may read RFID code information stored in the RFID tag attached to an individual tire in each process to provide the read information to the lot management server 10.

In the following, the action and effect of a tire production management system using an RFID tag according to an embodiment of the inventive concept are described in more detail with reference to the accompanying drawings.

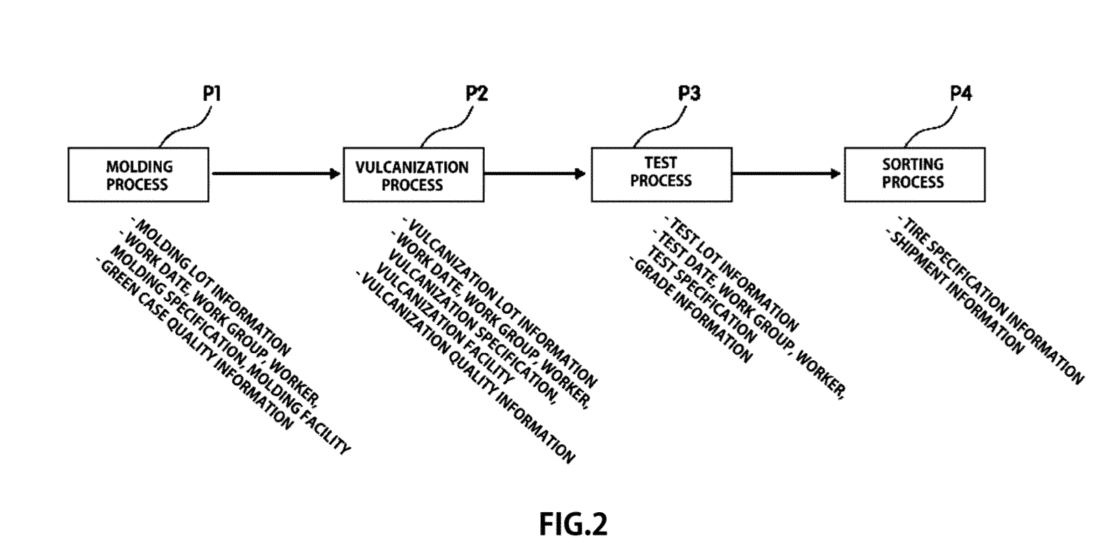

FIG. 2 shows an example of production information generated according to a tire manufacturing process in a tire production management system using an RFID tag according to an embodiment of the inventive concept.

As shown in FIG. 2, the tire manufacturing process may roughly include four processes, a molding process P1, a vulcanization process P2, a test process P3, and a sorting (shipment) process P4.

The molding process P1 is a process of assembling a semi-finished product for each part of a tire, such as a side wall, inner liner, tread, etc. that is manufactured by the rolling, extrusion, and cutting of a raw material, such as natural rubber, synthetic rubber, carbon, etc., to manufacture a green case.

The tire production management system using the RFID tag according to the embodiment of the inventive concept may attach the RFID tag to the green case manufactured in the molding process P1. The attachment of the RFID tag may be performed through the RFID attachment device 113. In the molding process P1, it is possible to read the RFID tag attached to the green case through the RFID tag attachment device 113 by using the RFID reader 112 and upload the read tire code information to the lot management server 10. The molding process management terminal 11 may generate production information applied to the molding facility 111 in the molding process P1 to upload the generated information to the lot management server 10.

Before describing the following processes, the RFID tag used for the tire production management system using an RFID tag according to the embodiment of the inventive concept is described.

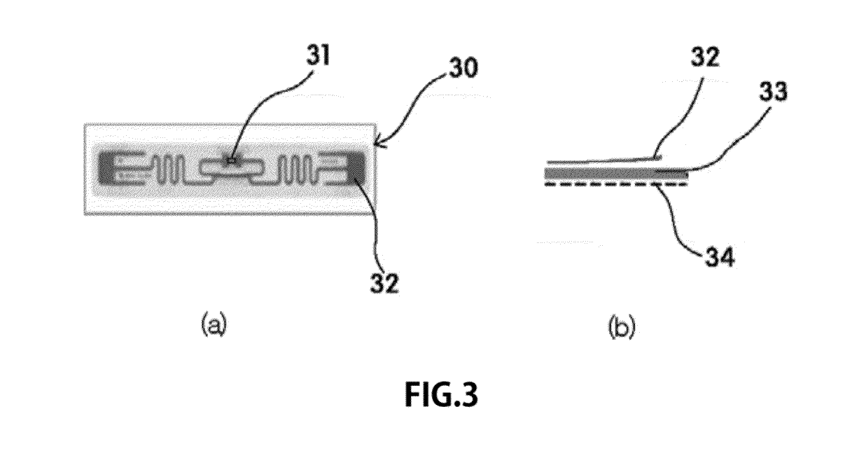

FIGS. 3a and 3b show an RFID tag used for a tire production management system using an RFID tag according to an embodiment of the inventive concept, in which FIG. 3a is a top view and FIG. 3b is a side cross-sectional view.

Referring to FIGS. 3a and 3b, the RFID tag 30 used for the tire production management system using the RFID tag according to the embodiment of the inventive concept may include a polyimide film 33 that is a thermosetting polymeric material, an RFID chip 31 that is disposed on a surface of the polyimide film 33, and an antenna pattern 32 that is electrically connected to the RFID chip 31 to resonate with the wave transmitted for wireless communication.

The polyimide film 33 is a polymeric film that has fusibility and thermostability, and is a material that may ensure mechanical reliability in that it does not melt even when a high-temperature, high-pressure vulcanization process is performed thereon, and in that it may be integrated with a tire when a tire material is cured. In addition, since the RFID tag for the tire may operate as one piece with the tire, it is possible to mitigate a physical, mechanical defect that may be at a position where the RFID tag for the tire has been inserted, by reflecting a change in stress or heat that the tire may have as it is, so it is possible to increase the life expectancy of the tire and the RFID tag for the tire. Also, even when the RFID tag for the tire is attached to the surface of the inner liner of the tire, it is possible to secure sufficient flexibility and thus easy to attach it to a curve, and since it is significantly light in weight and thin in thickness, it is possible to prevent separation from the tire, a damage or malfunction even under a high-speed rotation condition or high-temperature, high-pressure condition in which the tire operates.

For the RFID tag used for the tire production management system using the RFID tag according to the embodiment of the inventive concept, an adhesive 34 may be applied to a surface of the polyimide film 33 attached to the tire.

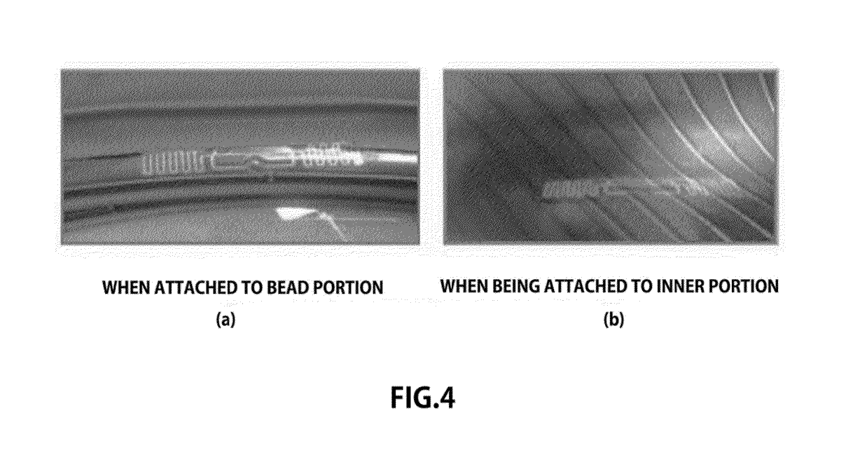

FIGS. 4a and 4b show examples of where an RFID tag used in a tire production management system using an RFID tag according to an embodiment of the inventive concept is attached to a tire.

The RFID tag used in the tire production management system using the RFID tag according to the embodiment of the inventive concept may be attached to the bead portion of a tire as shown in FIG. 4a or to the inner liner surface of the tire as shown in FIG. 4b.

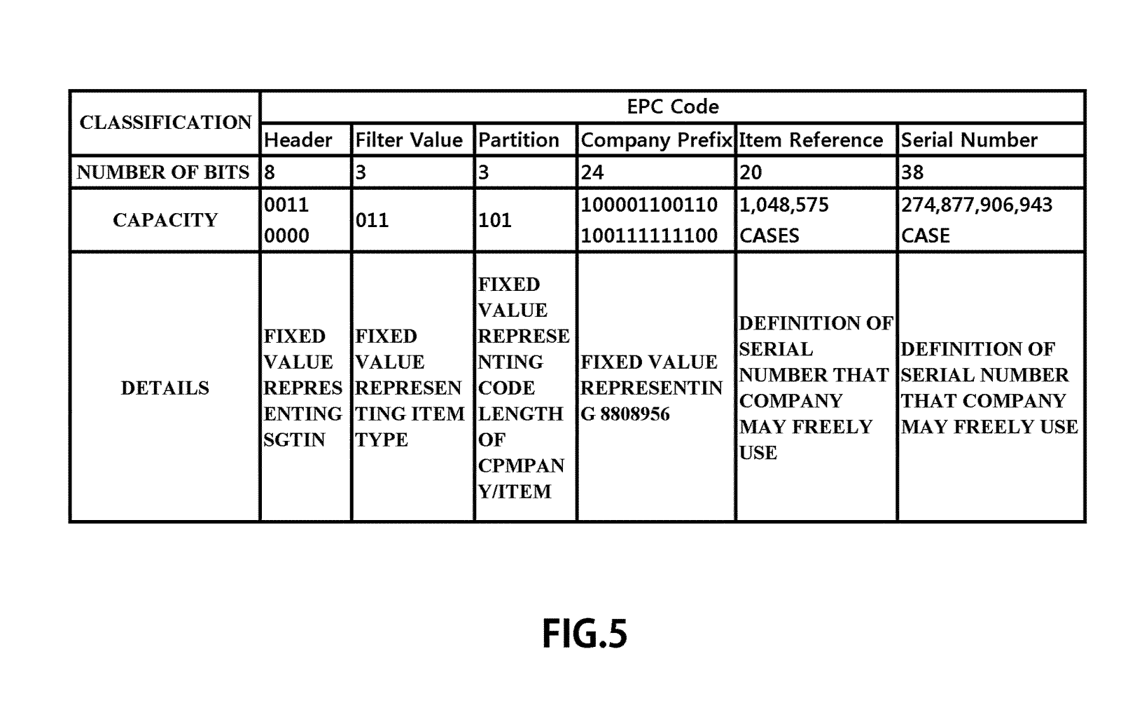

FIG. 5 shows a code system that is recorded on an RFID chip of an RFID tag used in a tire production management system using an RFID tag according to an embodiment of the inventive concept.

As shown in FIG. 5, the code system that is recorded on the RFID chip of the RFID tag used in the tire production management system using the RFID tag according to the embodiment of the inventive concept may employ an EPCglobal serialized global trade item number (SGTIN)-96 code system that is an international standard and has a 96-bit code length. Global standards one (GS1) is an international standard organization that includes about 100 countries, and code systems managed by the GS1 include barcode, EPGglobal (RFID), eCom (electronic document), etc. The Korea Chamber of Commerce & Industry (KCCI) has joined the GS1 on behalf of South Korea in 1988 and the trade and distribution promotion center of KCCI is distributing a barcode and RFID related international standard in South Korea as the representative organization of South Korea related to GS1. The RFID code system applied to the inventive concept employs the EPCglobal SGTIN-96 code system (code length: 96 bits), one of international standards, as described earlier. GTIN is the standard code system of GS1 applied currently to a tire barcode and SGTIN is a code system (EPCglobal standard code system of GS1) that is obtained by converting GTIN into the RFID code system.

As shown in FIG. 5, the RFID code applied to an embodiment of the inventive concept use predetermined fixed values for a header, a filter value, a partition, and a company prefix, and record information on the manufacturing factory of a tire by utilizing 20 bits allocated to item reference, and record the serial number of an individual tire by using 38 bits allocated to a serial number.

Referring back to FIG. 2, in the molding process P1, the RFID tag attachment device 113 may attach an RFID tag having a tire manufacturing factory and a tire serial number as codes to the green case manufactured through the molding process P1, as described earlier. Also, the RFID reader 112 may be disposed on a conveyor that moves the green case to the following process after the completion of the molding process P1, and recognize code information on the RFID tag attached to the moving green case.

The lot management server 10 may combine, RFID code information on an individual tire read from the RFID reader 112, with production information related to the molding process P1 generated by the molding process management terminal 11, and transmit the combined information to the tire production management server 1. Namely, in the molding process P1, the lot management server 10 may match the serial number of a tire in the RFID code information with production information that should be recorded in the molding process P1 of a tire having a corresponding serial number, and transmit information to the tire production management server 1.

For example, the production information related to the molding process P1 may include information on a molding lot to which an individual tire belongs, the work date on which the molding process P1 has been performed, molding equipment information, a worker and work group that has performed the molding process P1, and a molding specification. In addition, green case quality information that is determined in the intermediate test process after molding performed after the completion of the molding process may be included in the production information related to the molding process P1.

Subsequent to the molding process P1, the vulcanization process P2 may be performed. The vulcanization process P2 is a process of putting the green case manufactured in the molding process P1 in a finished-tire shaped mold and applying high temperature/high pressure (e.g., 200° C., 30 bar) to manufacture a finished tire.

It is also possible to recognize the RFID tag attached to a tire on which the vulcanization process P2 is being performed or has been completed, through the RFID reader 122 adjacent to or in a vulcanization facility 121 even in the vulcanization process P2. A vulcanization process management terminal 12 generates production information related to the vulcanization process P2. In the vulcanization process P2, the lot management server 10 may match the serial number of a tire in the RFID code information read from the RFID reader 122 with production information that should be recorded in the vulcanization process P2 of a tire having a corresponding serial number, and transmit information to the tire production management server 1.

For example, the production information related to the vulcanization process P2 may include information on a vulcanization lot to which an individual tire belongs, the work date on which the vulcanization process P2 has been performed, vulcanization equipment information, a worker and work group that have performed the vulcanization process P2, and a vulcanization specification. In addition, vulcanization quality information that is determined in the intermediate test process after vulcanization performed after the completion of the vulcanization process may be included in the production information related to the vulcanization process P2.

Subsequent to the vulcanization process P2, an test process P3 may be performed. In the test process P3, it is possible to perform the code recognition of an RFID tag attached to a tire on which the test process P3 is performed, through the RFID reader 132 adjacent to the conveyor when a finished tire manufactured through the vulcanization process P2 moves on the conveyor.

In the test process P3, it is possible to perform a balance test and a uniformity test on a finished tire manufactured through the vulcanization process P2. A test process management terminal 13 may generate test process related production information that includes information on a test result performed in the test process P3. The lot management server 10 may combine, code information on the RFID tag recognized by the RFID reader 132 in the test process P3, with the test process related production information generated by the test process management terminal 13, and provide the combined information to the tire production management server 1.

For example, the test process P3 related production information may include information on a test lot to which an individual tire belongs, the work date on which the test process P3 has been performed, a worker and work group that have performed the test process P3, a test specification, and grade information applied to an individual tire according to a test result.

After the test process P3 has been completed, a sorting process P4 may be performed. In the sorting process, it is possible to classify tires by specification and ship the classified tires. The RFID reader 142 used in the sorting process P4 may be a portable RFID reader that a worker may carry. In the case of a tire for a bus/truck where it is difficult for a worker to sort, the RFID reader 142 may also be employed which is specially manufactured to be capable of simultaneously recognizing a plurality of stacked tires through an antenna disposed in the holes of the plurality of stacked tires.

The sorting process management terminal 14 may generate production information related to the sorting and shipment performed in the sorting process P4 and upload the generated information to the lot management server 10. The lot management server 10 may combine, the production information generated by the sorting process management terminal 14, with code information on the RFID tag recognized by the RFID reader 142 and provide the combined information to the tire production management server 1.

For example, production information related to the sorting process P4 may include information on a specification of a sorted tire and shipment information (e.g., shipment date, the place of shipment).

The tire production management server 1 that receives the code information on the RFID tag attached to the tire and production information matching therewith in manufacturing processes for tire production may integrally realize a production history of an individual through the processing/analysis of the received information, generate and collect various pieces of information required for tire production management.

For example, the tire production management server 1 may use lot information provided in each process to generate/realize a lot state, generate/realize an inventory state according to each process, and generate/realize the quality state of a semi-finished/finished tire according to a facility which has been applied to each process and a quality state by day/month in which each process has been performed. Also, the tire production management server 1 may generate/realize an inventory according to a specification of the sorted tire, and generate/realize the place of shipment according to a tire specification. Also, the tire production management server 1 may collect daily production information to generate/manage production performance, generate/realize and manage the state of a tire, such as a defect/repair/disuse, according to various test results.

As described above, since the tire production management system using the RFID tag according to the embodiment of the inventive concept attaches an RFID tag including a recognition code of a corresponding tire to a green case manufactured in a tire molding process, and combines production information on each tire according to each production process of a tire with the recognition code of the RFID tag for integrated management, it is possible to perform history management according to a production process on an individual tire and it is possible to perform integrated tire production management.

Although the detailed description of the present invention has described particular embodiments, many variations may also be implemented without departing from the scope of the present invention. Therefore, the scope of the present invention is not limited to the above-described embodiments and should be defined by the scope of the claims and equivalents thereof.

1. A tire production management system using a radio frequency identification (RFID) tag, the tire production management system comprising:
an RFID tag attachment device attaching, an RFID tag on which an identification code of a tire is recorded, to a semi-finished tire which is made in an intermediate process for manufacturing the tire;
a plurality of RFID readers reading the identification code recorded on the RFID tag which is attached to the semi-finished tire made in each of a plurality of processes for manufacturing the tire, or to a finished tire;
a plurality of process-dependent management terminals disposed for the plurality of processes to generate production information on a corresponding process;
a lot management server combining the identification code read by the plurality of RFID readers with the production information generated by the for the process-dependent management terminals for the tire having a corresponding identification code; and
a tire production management server receiving, data in which the identification code is combined with the production information on the corresponding process, from the lot management server, and storing/managing tire production information.

2. The tire production management system according to claim 1, wherein the plurality of processes for manufacturing the tire comprises:
a molding process in which semi-finished products configuring a part of the tire are assembled and a green case is molded;
a vulcanization process in which heat/pressure is applied to the green case to make a shape of a finished-tire;
a test process in which the tire made in the vulcanization process is tested; and
a sorting process in which the tire on which the test process is completed is sorted by size.

3. The tire production management system according to claim 2, wherein the RFID tag attachment device attaches the RFID tag to the green case manufactured by the molding process.

4. The tire production management system according to claim 2 or 3, wherein the RFID tag attachment device attaches the RFID tag to a bead portion or an inner liner surface of the green case manufactured by the molding process.

5. The tire production management system according to claim 2, wherein the plurality of RFID readers and the plurality of process-dependent management terminals are disposed one by one at workplaces for the molding process, the vulcanization process, the test process, and the sorting process, and
the lot management server receives the identification code of the tire from the RFID reader in each process and the production information on each process from the process-dependent management terminal in each process, combines the identification code of the tire received in each process with the production information on a process that receives the identification code of the tire, and provides the combined information to the tire production management server.

6. The tire production management system according to claim 5, wherein the production information generated by the management terminal in the molding process comprises information on a molding lot to which an individual tire belongs, work date on which the molding process is performed, molding equipment information, a worker and work group that performs the molding process, and a molding specification.

7. The tire production management system according to claim 5, wherein the production information generated by the management terminal in the vulcanization process comprises information on a vulcanization lot to which an individual tire belongs, work date on which the vulcanization process is performed, vulcanization equipment information, a worker and work group that performs the vulcanization process, and a vulcanization specification.

8. The tire production management system according to claim 5, wherein the production information generated by the management terminal in the test process comprises information on a test lot to which an individual tire belongs, work date on which the test process is performed, a worker and work group that perform the test process, a test specification, and grade information assigned to an individual tire according to a test result.

9. The tire production management system according to claim 5, wherein the production information generated by the management terminal in the sorting process comprises specification information on a sorted, individual tire and information on shipment date and place of shipment.

10. The tire production management system according to claim 1, wherein the tire production management server uses lot information generated in each of the plurality of processes to generate a lot state, generates an inventory state according to each of the plurality of processes, and generates a quality state of a semi-finished/finished tire according to facilities applied to the plurality of processes and a quality state by day/month in which each process is performed.

11. The tire production management system according to claim 1, wherein the tire production management server generates an inventory according to a specification of a sorted tire, and generates place of shipment according to tire specification.

12. The tire production management system according to claim 1, wherein the tire production management server collects daily production information to generate/manage production performance, and generates a state of a tire according to various test results, such as a defect/repair/disuse.

13. The tire production management system according to claim 3, wherein the RFID tag attachment device attaches the RFID tag to a bead portion or an inner liner surface of the green case manufactured by the molding process.
